(19) United States
(12) Patent Application Publication
(10) Pub. No.: US 2024/0420510 A1
(43) Pub. Date: Dec. 19, 2024

(54) INFORMATION PROCESSING DEVICE, INFORMATION PROCESSING SYSTEM, AND INFORMATION PROCESSING METHOD

(71) Applicant: Panasonic Automotive Systems Co., Ltd., Kanagawa (JP)

(72) Inventors: Takashi HATANO, Kanagawa Ken (JP); Atsushi HIRAI, Tokyo To (JP); Takayoshi MORIYASU, Kanagawa Ken (JP)

(73) Assignee: Panasonic Automotive Systems Co., Ltd., Kanagawa (JP)

(21) Appl. No.: 18/817,921

(22) Filed: Aug. 28, 2024

Related U.S. Application Data
(63) Continuation of application No. PCT/JP2023/002885, filed on Jan. 30, 2023.

(30) Foreign Application Priority Data
Mar. 31, 2022 (JP) 2022-061012

(51) Int. Cl. G06V 40/20; G06V 10/25

(52) U.S. Cl. CPC G06V 40/28; G06V 10/25; G06V 2201/07

(57) ABSTRACT

An information processing device according to the present disclosure includes a memory in which a program is stored and a processor coupled to the memory and configured to perform processing by executing the program. The processing includes: receiving an image obtained by imaging a user; detecting an arm portion of the user based on the image; setting, based on a position of the arm portion of the user and a length of the arm portion of the user, a virtual operation region for accepting an operation on an individual device; and operating the individual device based on a positional relation between a position of a fingertip of the user received from the image and the virtual operation region.

### CROSS-REFERENCE TO RELATED APPLICATIONS

This application is a continuation of International Application No. PCT/JP2023/002885, filed on Jan. 30, 2023 which claims the benefit of priority of the prior Japanese Patent Application No. 2022-061012, filed on Mar. 31, 2022, the entire contents of which are incorporated herein by reference.

### FIELD

Embodiments described herein relate generally to an information processing device, an information processing system, and an information processing method.

### BACKGROUND

There have been various devices that detect a movement of a hand of a user and perform motion control according to the movement of the hand of the user (see, for example, JP 2018-32055 A). For example, for an operation target such as a display, the user changes, according to the movement of the hand of the user, content displayed on the display without directly touching the display.

In the technique explained above, it is conceivable to set a virtual operation region for specifying a selection operation or the like of the user. It is desirable that such a virtual operation region is set to be easily operated by the user.

The present disclosure provides an information processing device that can set a virtual operation region that is easy for a user to operate.

### SUMMARY

An information processing device according to an embodiment of the present disclosure includes a memory in which a program is stored and a processor coupled to the memory and configured to perform processing by executing the program. The processing includes: receiving an image obtained by imaging a user; detecting an arm portion of the user based on the image; setting, based on a position of the arm portion of the user and a length of the arm portion of the user, a virtual operation region for accepting an operation on an individual device; and operating the individual device based on a positional relation between a position of a fingertip of the user received from the image and the virtual operation region.

### BRIEF DESCRIPTION OF THE DRAWINGS

FIG. 1 is a diagram illustrating an example of an information processing device;

FIG. 2A is a diagram illustrating an example of an operation instruction viewed from above;

FIG. 2B is a diagram illustrating the example of the operation instruction viewed from a side;

FIG. 3A is a diagram illustrating an example of a detection range;

FIG. 3B is a table illustrating whether areas can be detected;

FIG. 4A is a diagram illustrating an example of erroneous detection;

FIG. 4B is a diagram illustrating another example of erroneous detection;

FIG. 5 is a block diagram illustrating a functional configuration of an information processing device according to a first embodiment;

FIG. 6A is a diagram illustrating a touch determination surface viewed from above;

FIG. 6B is a diagram illustrating the touch determination surface viewed from a side;

FIG. 7A is a diagram illustrating the touch determination surface viewed from above;

FIG. 7B is a diagram illustrating the touch determination surface viewed from the side;

FIG. 8A is a diagram illustrating the touch determination surface viewed from above;

FIG. 8B is a diagram illustrating the touch determination surface viewed from the side;

FIG. 9A is a diagram illustrating the touch determination surface viewed from above;

FIG. 9B is a diagram illustrating the touch determination surface viewed from the side;

FIG. 10A is a diagram illustrating a detection enabled region viewed from above;

FIG. 10B is a diagram illustrating the detection enabled region viewed from a side;

FIG. 11 is a flowchart illustrating a processing procedure according to a second embodiment;

FIG. 12 is a diagram illustrating an effect of a control device according to the second embodiment;

FIG. 13 is a diagram illustrating an example of setting a touch determination surface of each of a plurality of users;

FIG. 14 is a flowchart illustrating a processing procedure according to a third embodiment;

FIG. 15 is a diagram for explaining an example of image removal according to a fourth embodiment;

FIG. 16A is a diagram for explaining an example of image removal according to the fourth embodiment;

FIG. 16B is a diagram for explaining the example of the image removal according to the fourth embodiment;

FIG. 17 is a flowchart illustrating a processing procedure according to the fourth embodiment;

FIG. 18 is a diagram illustrating a disposition position of a sensor according to a modification;

FIG. 19 is a diagram illustrating a disposition position of the sensor according to the modification;

FIG. 20 is a diagram illustrating a disposition position of the sensor according to the modification;

FIG. 21 is a diagram illustrating an example of a display according to the modification;

FIG. 22 is a diagram illustrating an example of touch determination surfaces of a plurality of devices;

FIG. 23 is a diagram illustrating an example of the touch determination surfaces of the plurality of devices;

FIG. 24A is a diagram illustrating a touch determination surface based on the left arm;

FIG. 24B is a diagram illustrating a touch determination surface based on the right arm;

FIG. 25A is a diagram illustrating a detection enabled region based on both the arms; and

FIG. 25B is a diagram illustrating the detection enabled region based on both the arms.

### DETAILED DESCRIPTION

Embodiments of an information processing device according to the present disclosure will be explained below with reference to the drawings.

### First Embodiment

Before an information processing device according to a first embodiment is explained, a device that operates based on a movement of an arm portion of a user is explained.

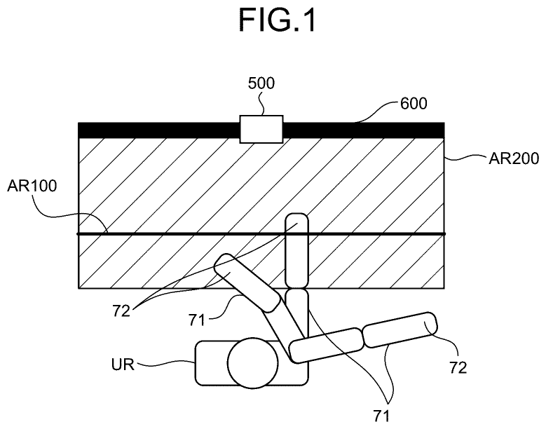

FIG. 1 illustrates an example of an information processing device that operates based on a movement of the arm portion of the user. The information processing device includes a sensor 500 and a display 600. The sensor 500 is, for example, a camera. The sensor 500 continues to image a user UR. The user UR has an arm 71. Here, the arm 71 includes not only an upper arm and a forearm but also a hand. The hand also includes a fingertip 72. The information processing device controls, based on the position of the fingertip 72 of user UR, data displayed on the display 600.

The information processing device sets a touch determination surface AR100 that accepts an operation on a device (for example, the display 600) and a detection enabled region AR200 that is a region for detecting a movement of the fingertip 72 of the user UR. In this example, the touch determination surface AR100 is set as a plane parallel to a display surface of the display 600.

When the fingertip 72 enters a range closer to the display 600 than the touch determination surface AR100, the information processing device detects that an operation instruction to the information processing device has been given, executes processing based on the operation instruction, and displays an execution result on the display 600.

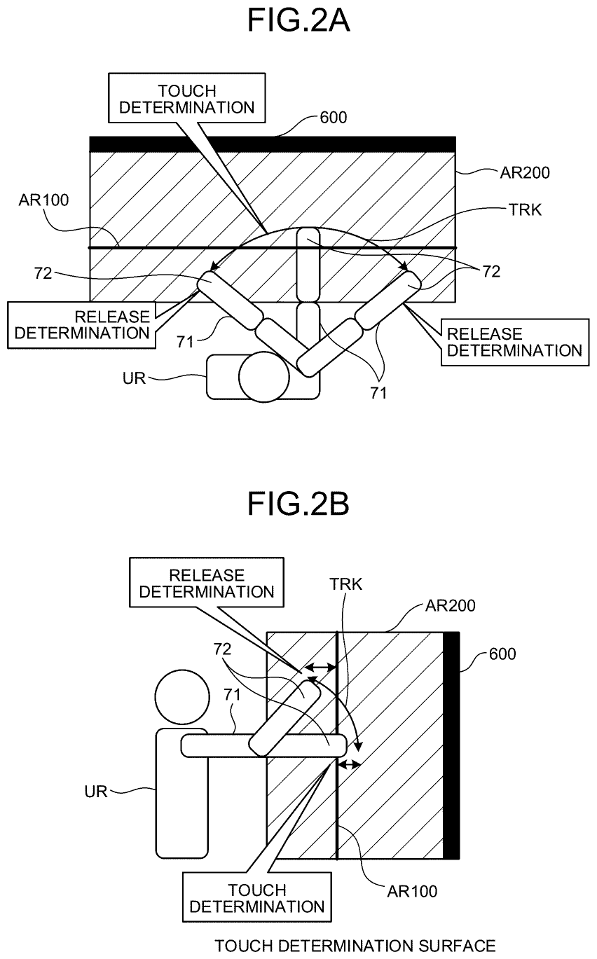

Subsequently, an example in which an operation instruction for the information processing device is given by the user UR is explained with reference to FIGS. 2A and 2B. FIG. 2A is a diagram illustrating an operation example of the user UR viewed from above. FIG. 2B is a diagram illustrating the operation example of user UR viewed from a side.

As illustrated in FIGS. 2A and 2B, when the fingertip 72 enters a range of the touch determination surface AR100 (In other words, the fingertip 72 is located closer to the display 600 than the touch determination surface AR100), the information processing device determines that a predetermined place of the display 600 has been touched. The touch determination surface AR100 is a region for accepting an operation on the display 600. In the following explanation, the information processing device determining that the fingertip 72 of the user UR has touched a predetermined place on the display 600 is sometimes referred to as touch detection. When the user UR moves the fingertip 72 in a direction away from the touch determination surface AR100 along a track TRK, an information processing device 100 determines that the fingertip 72 has transitioned from a state of touching the predetermined place on the display 600 to a released state.

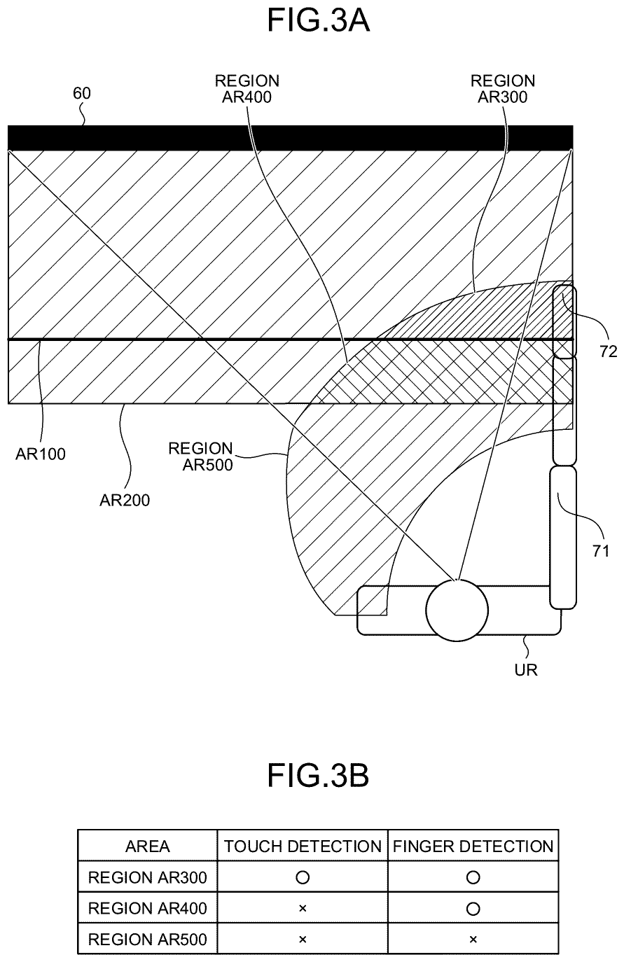

Subsequently, a relation among a range in which the user UR can move the fingertip 72, the touch determination surface AR100, and the detection enabled region AR200 is illustrated with reference to FIGS. 3A and 3B. Note that, in this example, the display 600 loaded on the vehicle is assumed, and it is assumed that the user UR is seated on a seat on the right side. For that reason, the user UR is located closer to the right side in the drawing. Here, in the detection enabled region AR200, a finger of the user UR can be detected. The finger detection is detecting a position where a finger of the user UR is present. When the finger of the user UR is located in the detection enabled region AR200, the finger can be detected.

As illustrated in FIG. 3A, a range in which user UR can move the fingertip 72 is a range obtained by combining a region AR300, a region AR400, and a region AR500.

The region AR300 is a region located in a range closer to the display 600 than the touch determination surface AR100 in a range in which the user UR is capable of moving the fingertip 72. For that reason, as illustrated in FIG. 3B, the information processing device 100 is capable of performing touch detection and finger detection in the region AR300.

The region AR400 is a region located in a range farther from the display 600 than the touch determination surface AR100 in the range in which the user UR is capable of moving the fingertip 72 but included in the detection enabled region AR200. Accordingly, as illustrated in FIG. 3B, the region AR400 is a region where the touch detection cannot be performed but the finger detection can be performed.

The region AR500 is a region located in a range farther from the display 600 than the touch determination surface AR100 in the range in which the user UR is capable of moving the fingertip 72 and not included in the detection enabled region AR200. Accordingly, as illustrated in FIG. 3B, the region AR500 is a region where neither the touch detection nor the finger detection can be performed.

In an example illustrated in FIG. 3A, there is a problem in that a region where the touch detection is possible, that is, a range in which user UR is capable of operating the display 600 is small in the range in which user UR is capable of moving the fingertip 72.

As a method of solving this problem, a method of bringing the touch determination surface AR100 close to the position of the user UR is conceivable. In the following explanation, a range closer to the display 600 than the touch determination surface AR100 is sometimes referred to as a range in which the touch detection is possible.

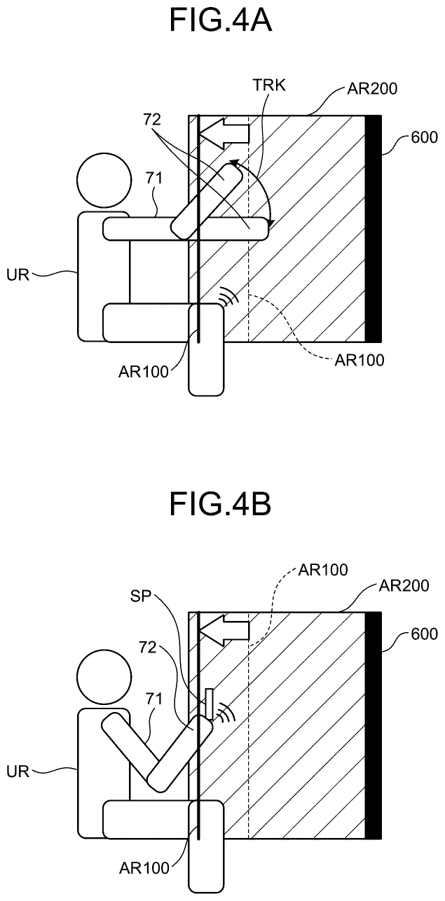

Here, FIGS. 4A and 4B illustrate an example in which the touch determination surface AR100 is brought close to the position of the user UR. When the touch determination surface AR100 is brought close to the position of the user UR, as illustrated in FIG. 4A, the fingertip 72 of the user UR easily reaches the range in which the touch detection is possible. On the other hand, it is likely that a portion other than the fingertip 72 of the user UR such as a knee of user UR enters the range in which the touch detection is possible, and the information processing device erroneously detects a movement of the portion other than the fingertip 72 of user UR as touch operation. As illustrated in FIG. 4B, it is likely that the information processing device erroneously detects a movement of the fingertip 72 of the user UR as touch operation in spite of the fact that the user UR does not have an intention to operate the display 600, for example, the user UR is operating a smartphone SP.

As explained above, even if the touch determination surface AR100 is simply brought close to the user UR, this is likely to lead to erroneous detection. Therefore, the information processing device according to the first embodiment sets a virtual operation region that is easy for the user UR to operate.

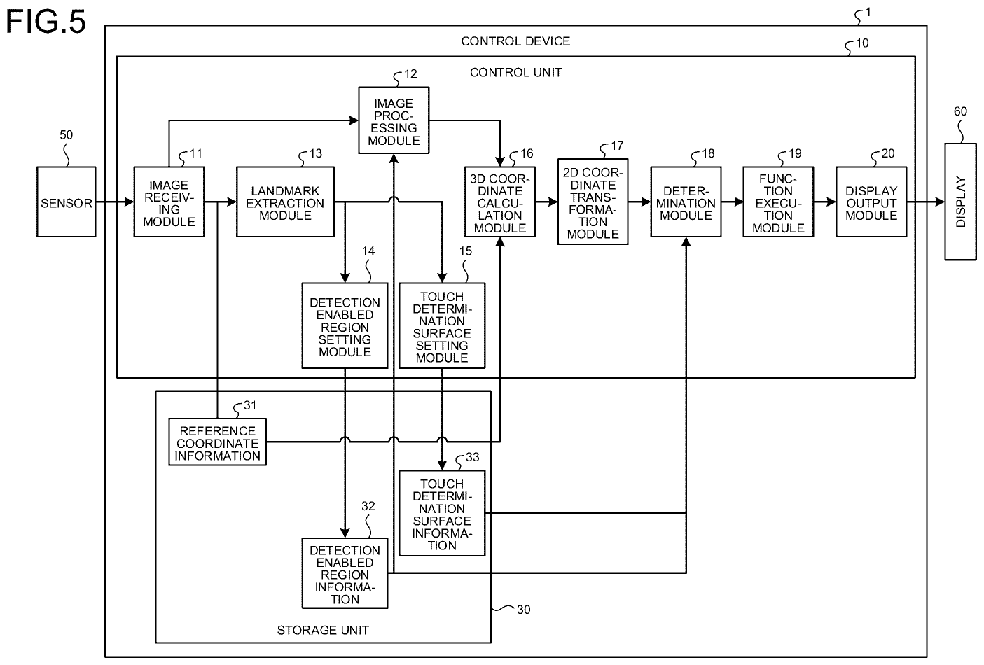

FIG. 5 is a diagram illustrating a schematic configuration of an information system including a control device 1 that is the information processing device according to the first embodiment. The information processing device according to the first embodiment includes a sensor 50, a control device 1, and a display 60.

The sensor 50 is, for example, a camera device. The sensor 50 is, as an example, a visible light camera. The sensor 50 outputs a captured image of the user UR to the control device 1. Note that the sensor 50 is not limited to the visible light camera and may be, for example, a CCD camera or a CMOS camera. The sensor 50 is an example of an imaging unit. The sensor 50 continuously executes imaging processing and outputs an image to the control device 1.

The display 60 is a display unit that displays various data. The display 60 is an example of a device.

The control device 1 executes, according to a movement of the fingertip 72 of the user UR, processing of data displayed on the display 60.

The control device 1 includes a control unit 10 and a storage unit 30. The control unit 10 is configured as, for example, a CPU (Central Processing Unit) and collectively controls operations of the units of the control device 1. The control unit 10 includes an image receiving module 11, an image processing module 12, a landmark extraction module 13, a detection enabled region setting module 14, a touch determination surface setting module 15, a 3D coordinate calculation module 16, a 2D coordinate transformation module 17, a determination module 18, a function execution module 19, and a display output module 20. The control device 1 includes, for example, a processor and a memory. The processor executes a program stored in the memory, whereby the control device 1 implements functions of the control unit 10 and the functional blocks included in the control unit 10. The CPU is an example of the processor. The storage unit 30 is an example of the memory.

The storage unit 30 stores various kinds of information. The storage unit 30 is implemented by hardware for storing information (in other words, data) such as a memory or a storage. Specifically, the storage unit 30 stores reference coordinate information 31, detection enabled region information 32, and touch determination surface information 33. The reference coordinate information 31 is a 3D coordinate of an installation position of the sensor 50, information concerning an attachment angle of the sensor 50, a 3D coordinate of the position of the display 60, and the like. The detection enabled region information 32 is coordinate information indicating a detection enabled region. The detection enabled region is a region for detecting a position change of the fingertip 72 of the user UR. The touch determination surface information is coordinate information indicating a touch determination surface. The touch determination surface is a region for accepting an operation on the display 60.

The image receiving module 11 receives an image from the sensor 50. The image receiving module 11 is an example of the image receiving module. The image processing module 12 processes, as a removal target, a region where the user UR is not imaged in the image receiving module 11. The landmark extraction module 13 detects a landmark portion of the user UR from an image in which the user UR is image and extracts a portion to be the landmark. Here, the landmark is a three-dimensional coordinate of the eyes and the shoulder of the user UR or the arm portion of the user UR. Note that the landmark extraction module 13 may extract the length of the arm portion of the user. The landmark extraction module 13 may extract information indicating a visual field range of the user UR based on the position of the eyes of the user UR. The landmark extraction module 13 is an example of a detection module.

The detection enabled region setting module 14 sets the detection enabled region and registers the detection enabled region information 32, which is a coordinate indicating the detection enabled region, in the storage unit 30. A method with which the detection enabled region setting module 14 sets the detection enabled region is explained below. The detection enabled region setting module 14 is an example of the setting module. The detection enabled region is an example of the detection region.

The touch determination surface setting module 15 sets a touch determination surface and registers the touch determination surface information 33, which is a coordinate indicating a touch determination surface coordinate, in the storage unit 30. The touch determination surface setting module 15 is an example of the setting module. A method with which the touch determination surface setting module 15 sets the touch determination surface is explained below. The touch determination surface is an example of the virtual operation region.

The 3D coordinate calculation module 16 calculates a three-dimensional coordinate of a fingertip of the user UR. The 2D coordinate transformation module 17 transforms the three-dimensional coordinate of the fingertip of the user UR into a two-dimensional coordinate on the display 60.

The determination module 18 determines presence or absence of a touch and processing content from the touch determination surface and the three-dimensional coordinate of the fingertip. The processing content is, for example, touch, flick, or drag.

The function execution module 19 executes the processing contents based on a result of the determination by the determination module 18. The display output module 20 causes the display 60 to display a result of executing the processing content. The determination module 18, the function execution module 19, and the display output module 20 are examples of an operation module.

### Touch Determination Surface Setting Method

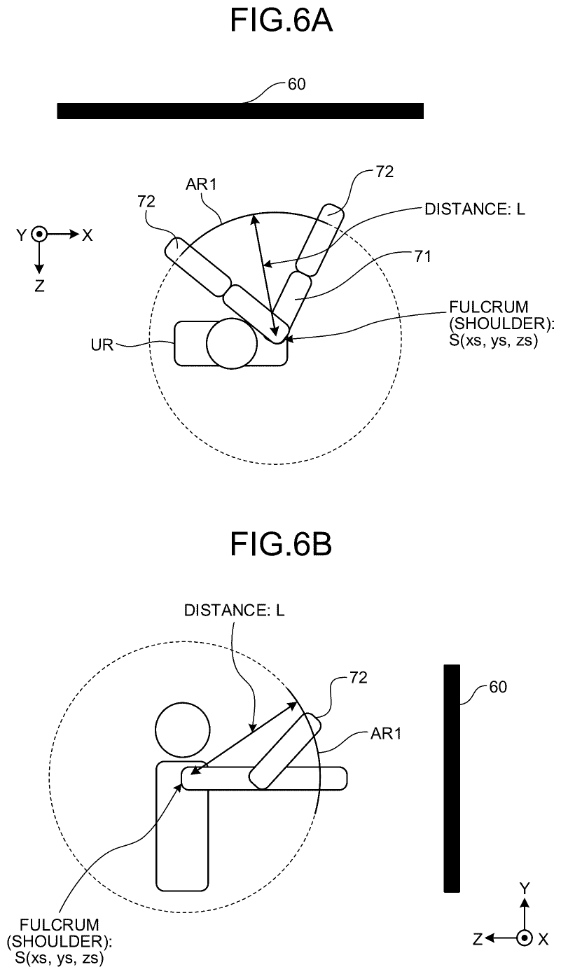

Subsequently, a method with which the touch determination surface setting module 15 sets the touch determination surface is explained. First, an example of setting the touch determination surface is explained with reference to FIGS. 6A and 6B. As a premise, the image receiving module 11 receives an image including the user UR. The landmark extraction module 13 extracts the shoulder portion, the arm portion, and the eye portion of the user UR from the image including the user UR. Note that the landmark extraction module 13 may extract the position of an elbow of the arm portion of the user UR.

FIG. 6A is a diagram illustrating the touch determination surface viewed from above. FIG. 6B is a diagram illustrating a touch determination surface viewed from a side.

As illustrated in FIGS. 6A and 6B, the touch determination surface setting module 15 sets a touch determination surface AR1 based on the following spherical Expression (1) including a distance L based on the length of the arm with the shoulder portion set as a center position S(xs, ys, zs).

$${( X - xs )}^{2} + {( Y - ys )}^{2} + {( Z - zs )}^{2} = {L}^{2} \qquad ( 1 )$$

Note that the distance L is a distance based on the length of the arm 71 and is, for example, length equal to or smaller than the length of the entire arm 71. The distance L is, for example, the length of the entire arm 71. As explained above, the touch determination surface setting module 15 sets the touch determination surface AR1 based on the position of the shoulder of the user UR and the length of the arm 71 of the user UR. The touch determination surface setting module 15 sets the touch determination surface AR1 based on the above Expression (1) to thereby set the touch determination surface based on a spherical range. The touch determination surface AR1 may be an entire spherical surface indicated by Expression (1) or may be a part of the spherical surface as illustrated in FIGS. 6A and 6B. For example, a part of the spherical surface indicated by Expression (1) may be set as the touch determination surface AR1 based on a movable range of the fingertip 72 of the user UR.

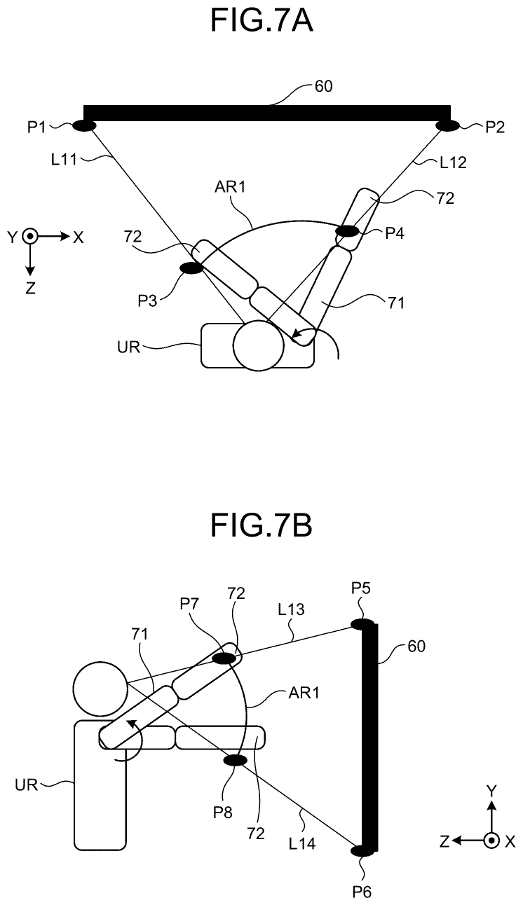

Note that the touch determination surface setting module 15 may set the touch determination surface AR1 further based on a visual field range of the user UR. Here, a method of setting the touch determination surface AR1 by the touch determination surface setting module 15 is explained with reference to FIGS. 7A and 7B.

FIG. 7A is a diagram illustrating the touch determination surface viewed from above. FIG. 7B is a diagram illustrating the touch determination surface viewed from the side. Here, a range from the position of the eyes of the user to the end of the display 60 is set as the visual field range. Specifically, when viewed from above, a range surrounded by a plane L11, which is a plane including the position of the eye of the user UR and the right end side of the display 60, a plane L12, which is a plane including the position of the eye of the user UR and the left end side of the display 60, and the display 60 is set as the visual field range. In FIG. 7A, the plane L11 and the plane L12 are illustrated as straight lines. When viewed from the side, a range surrounded by a plane L13, which is a plane including the position of the eye of the user UR and the upper end side of the display 60, a plane L14, which is a plane including the position of the eye of the user UR and the lower end side of the display 60, and the display 60 is set as the visual field range. In FIG. 7B, the plane L13 and the plane L14 are illustrated as straight lines. The touch determination surface setting module 15 sets the touch determination surface AR1 based on the arm 71 and the visual field range explained above. Specifically, the touch determination surface setting module 15 sets, as the touch determination surface AR1, only a portion included in the visual field range in the spherical surface indicated by Expression (1). As illustrated in FIG. 7A, a position P3 on the touch determination surface AR1 corresponds to a position P1 of the display 60 and a position P4 on the touch determination surface AR1 corresponds to a position P2 of the display 60. As illustrated in FIG. 7B, a position P7 on the touch determination surface AR1 corresponds to a position P5 of the display 60 and a position P8 on the touch determination surface AR1 corresponds to a position P6 of the display 60.

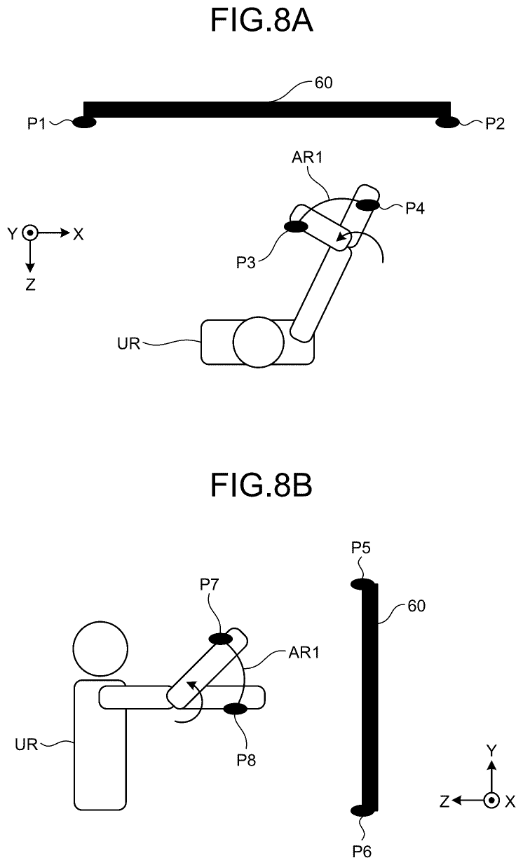

Another example of setting the touch determination surface AR1 is explained with reference to FIGS. 8A and 8B. FIG. 8A is a diagram illustrating the touch determination surface viewed from above. FIG. 8B is a diagram illustrating the touch determination surface viewed from the side. As illustrated in FIGS. 8A and 8B, the touch determination surface setting module 15 may set the touch determination surface AR1 with the elbow portion of the arm set as the center. In this case, the touch determination surface setting module 15 sets the touch determination surface AR1 based on the length from the elbow to the hand in the arm 71. The length from the elbow to the hand indicates the length from the elbow to the fingertip.

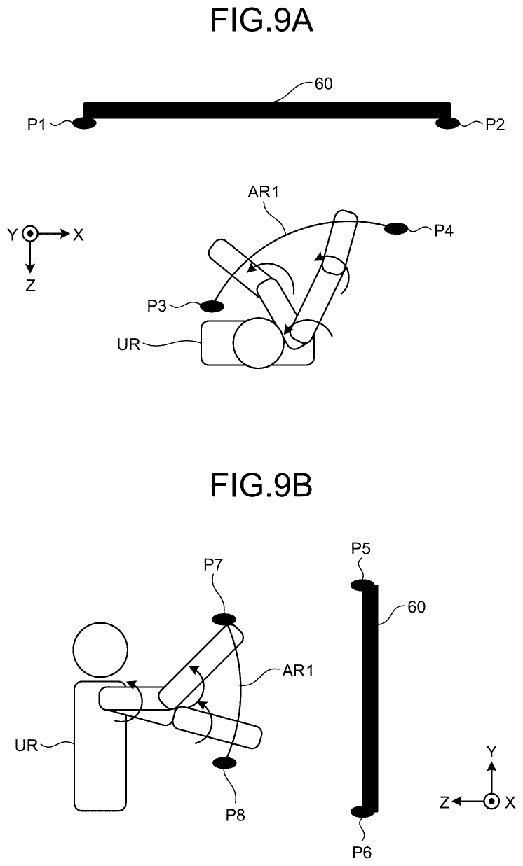

Another example of setting the touch determination surface AR1 is explained with reference to FIGS. 9A and 9B. FIG. 9A is a diagram illustrating the touch determination surface viewed from above. FIG. 9B is a diagram illustrating the touch determination surface viewed from the side. As illustrated in FIGS. 9A and 9B, the touch determination surface setting module 15 may set the touch determination surface AR1 centering on the shoulder and the elbow portion in the arm.

After the touch determination surface setting module 15 sets the touch determination surface AR1, when having determined, based on a positional relation between the position of the finger portion of the hand of the user UR received from the image and the touch determination surface AR1, that the fingertip 72 of the user UR is in a state of passing the touch determination surface AR1 (in other words, is in a touch detection state), the determination module 18 executes the function with the function execution module 19. The display output module 20 causes the display 60 to display an execution result.

In the control device 1 according to the first embodiment, the image receiving module 11 receives an image obtained by imaging the user, the landmark extraction module 13 detects the arm portion of the user UR, and the touch determination surface setting module 15 sets the touch determination surface AR1 based on the length of the arm with the shoulder portion set as the center position. When having determined, based on the positional relation between the position of the fingertip 72 of the user UR received from the image and the touch determination surface AR1, that the fingertip 72 is in the touch detection state, the determination module 18 executes the function with the function execution module 19. The display output module 20 causes the display 60 to display an execution result.

As explained above, since the control device 1 sets the touch determination surface AR1 based on the length of the arm portion of the user UR, it is possible to set the touch determination surface AR1 corresponding to a motion of the user. That is, it is possible to set a virtual operation region that is easy for the user to operate.

The control device 1 sets the touch determination surface AR1 based on the length of the arm 71 with the shoulder portion set as the center position, in other words, sets the touch determination surface AR1 based on the movable range of the arm 71. As explained above, the control device 1 sets the touch determination surface AR1 based on the movable range of the arm 71. Accordingly, unintended touch/release operation is less easily performed compared with when a touch determination surface AR600 is set in parallel with the display 600 as illustrated in FIG. 1.

The touch determination surface setting module 15 may set the touch determination surface AR1 based on the length from the elbow to the hand of the user UR or may set the touch determination surface AR1 based on the length of the entire arm 71 of the user UR. In this case as well, it is possible to set the touch determination surface AR1 corresponding to an operation of the user. The touch determination surface setting module 15 may set the touch determination surface AR1 further based on the visual field range of the user UR. In this case, since the control device 1 further limits the visual field range of the user UR, it is possible to set the touch determination surface AR1 that is easier for the user to operate.

### Second Embodiment

Subsequently, the control device 1 according to a second embodiment is explained. In the control device 1 according to the second embodiment, a detection enabled region that is easy for a user to operate is set.

### Detection Enabled Region Setting Method

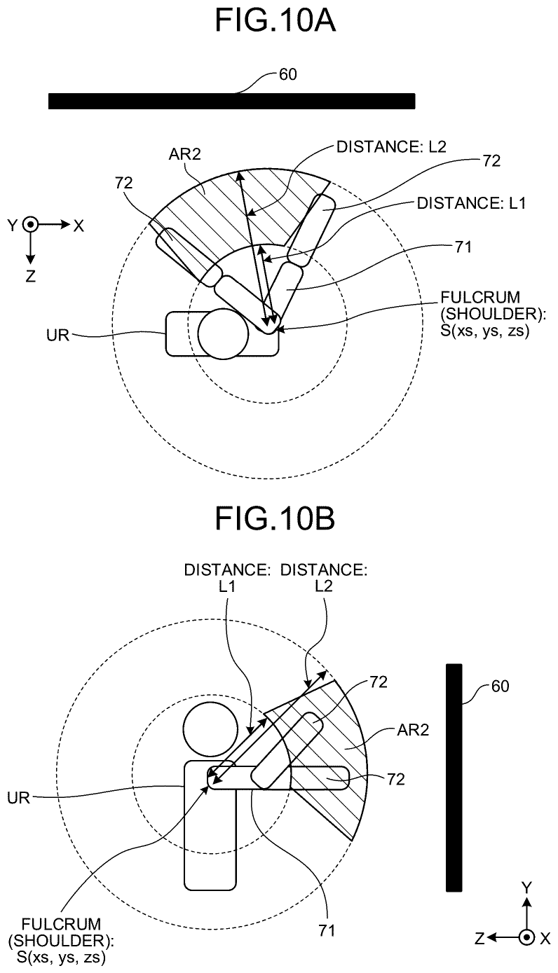

A method of the detection enabled region setting module 14 setting the detection enabled region is explained. First, an example of setting the detection enabled region is explained with reference to FIGS. 10A and 10B. As a premise, the image receiving module 11 receives an image including the user UR. The landmark extraction module 13 extracts the shoulder portion, the arm portion, and the eye portion of the user UR from the image including the user UR. Note that the landmark extraction module 13 may extract the position of an elbow of the arm portion of the user UR.

FIG. 10A is a diagram illustrating a positional relation between the user UR and the display 60 viewed from above. FIG. 10B is a diagram illustrating the positional relation between the user UR and the display 60 viewed from a side.

As illustrated in FIGS. 10A and 10B, the detection enabled region setting module 14 sets a detection enabled region AR2 based on the following spherical Expressions (2) and (3) including a distance L1 based on the length of the arm and a distance 12 based on the length of the arm with the shoulder portion set as a center position S(xs, ys, zs).

$$\begin{matrix}{( X - xs )}^{2} + {( Y - ys )}^{2} + {( Z - zs )}^{2} \geq L {1}^{2} & ( 2 ) \\ {( X - xs )}^{2} + {( Y - ys )}^{2} + {( Z - zs )}^{2} \leq L {2}^{2} & ( 3 )\end{matrix}$$

The detection enabled region setting module 14 sets a region satisfying the above Expressions (2) and (3) as the detection enabled region AR2. Note that L1<L2. A relation among the distance L explained above in the first embodiment, the distance L1, and the distance L2 is indicated as L1≤L≤L2. The distance L1 is, for example, length equal to or smaller than the length of the entire arm 71. The distance L1 is, for example, the length from the shoulder to the elbow in the arm. The distance L2 is, for example, a length equal to or smaller than the length of the entire arm 71. The distance L2 is, for example, the length of the entire arm 71.

As explained above, the detection enabled region setting module 14 sets the detection enabled region AR2 based on the length of the arm 71 of the user UR. The detection enabled region AR2 may be the entire region indicated by the Expressions (2) and (3) or may be a part of the region indicated by the Expressions (2) and (3) as illustrated in FIGS. 10A and 10B. For example, based on the movable range of the fingertip 72 of the user UR, a part of the region indicated by Expression (2) and (3) may be set as the detection enabled region AR2.

As in the example of the first embodiment, the detection enabled region setting module 14 may set the detection enabled region AR2 with the elbow portion set as the center position or may set the detection enabled region AR2 with both of the shoulder and the elbow set as the fulcrum.

As in the example of the first embodiment, the detection enabled region setting module 14 may set the detection enabled region AR2 further based on the visual field range of the user UR.

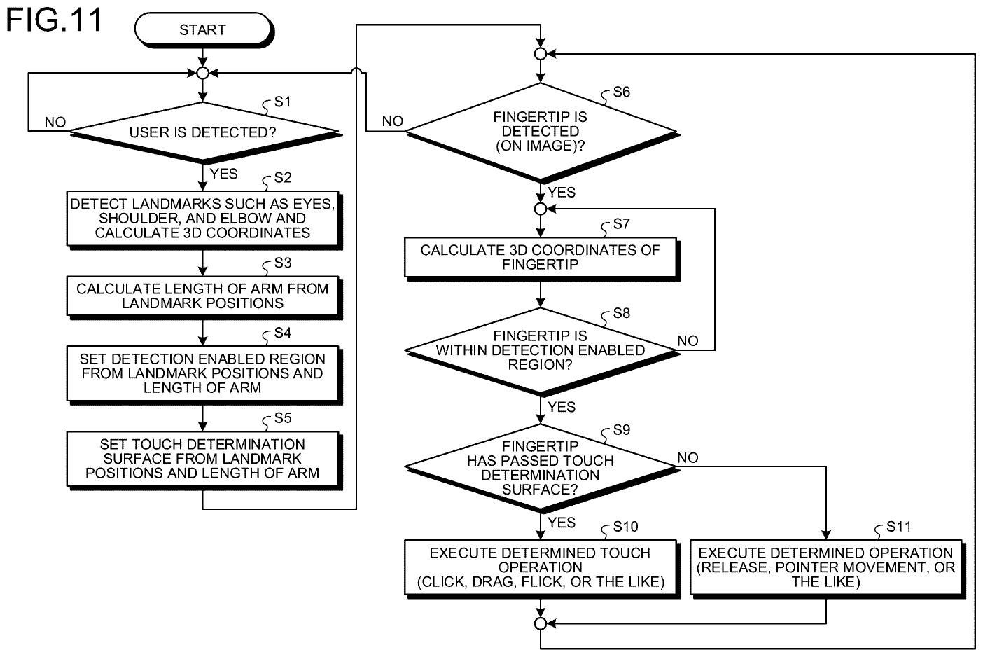

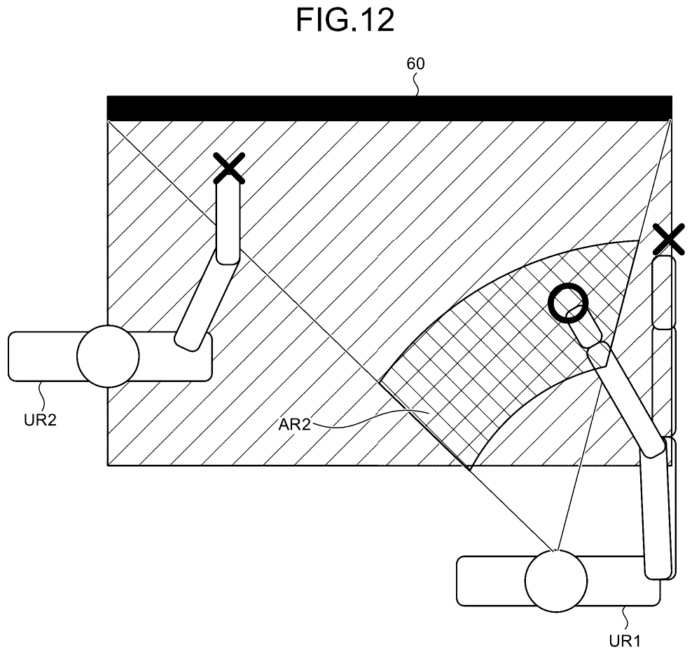

Subsequently, a processing procedure of the control device 1 according to the second embodiment is explained with reference to FIG. 11. FIG. 11 is a flowchart illustrating the processing procedure of the control device 1 according to the second embodiment.

First, the landmark extraction module 13 determines whether the user is detected from an image received by the image receiving module 11 (Step S1). When the landmark extraction module 13 determines that the user is not detected from the image (Step S1: No), the processing proceeds to Step S1 again. When it is determined that the user is detected from the image (Step S1: Yes), the landmark extraction module 13 detects landmarks such as the eyes, the shoulders, and the elbows and calculates 3D coordinates of the landmarks (Step S2).

The landmark extraction module 13 calculates the length of the arm of the user based on the positions of the landmarks (Step S3).

The detection enabled region setting module 14 sets a detection enabled region based on the landmark positions and the length of the arm of the user (Step S4). The touch determination surface setting module 15 sets a touch determination surface based on the landmark positions and the length of the arm of the user (Step S5). The 3D coordinate calculation module 16 determines whether the fingertip 72 of the user UR has been detected on the image (Step S6). In Step S6, when the 3D coordinate calculation module 16 determines that the fingertip of the user UR is not detected from the image (Step S6: No), the processing proceeds to Step S1. When it is determined that the fingertip of the user UR is detected from the image (Step S6: Yes), the 3D coordinate calculation module 16 calculates 3D coordinates of the fingertip (Step S7). The determination module 18 determines whether the 3D coordinate of the fingertip is within the detection enabled region AR2 (Step S8). When the determination module 18 has determined that the fingertip is not within the detection enabled region AR2 (Step S8: No), the processing proceeds to Step S7.

When having determined in Step S8 that the 3D coordinate of the fingertip is within the detection enabled region AR2 (Step S8: Yes), the determination module 18 determines whether the fingertip has passed the touch determination surface (Step S9). When having determined in Step S9 that the fingertip has passed the touch determination surface AR1 (Step S9: Yes), the determination module 18 determines operation corresponding to the movement of the fingertip. The operation corresponding to the movement of the fingertip is, for example, touch operation. Specific examples of the touch operation include click operation, drag operation, and flick operation. The function execution module 19 executes the determined operation (Step S10). When having determined in Step S9 that the fingertip has not passed the touch determination surface AR1 (Step S9: No), the determination module 18 determines operation corresponding to the movement of the fingertip. The operation corresponding to the movement of the fingertip is, for example, release operation or pointer movement operation. The function execution module 19 executes the determined operation (Step S11).

In the control device 1 according to the second embodiment, the detection enabled region setting module 14 sets the detection enabled region AR2 based on the length of the arm with the shoulder portion set as the center position. The determination module 18 determines operation corresponding to the movement of the fingertip based on a positional relation between the position of the fingertip 72 of the user UR received from the image and the detection enabled region AR2. The function execution module 19 executes a function corresponding to the operation. The display output module 20 causes the display 60 to display an execution result.

As explained above, since the control device 1 sets the detection enabled region AR2 based on the length of the arm portion of the user UR, it is possible to set the detection enabled region AR2 corresponding to a motion of the user. That is, it is possible to set a detection enabled region that is easy for the user to operate.

As illustrated in FIG. 12, the control device 1 sets the detection enabled region AR2 based on the length of the arm 71 of a user UR1. Consequently, even if a user UR2 operates around the display 60, the user UR2 is not included in the detection enabled region AR2. Therefore, it is possible to avoid the control device 1 erroneously detecting a motion of another user.

### Third Embodiment

Subsequently, the control device 1 according to a third embodiment is explained. The control device 1 according to the third embodiment sets a detection enabled region and a touch determination surface for each of a plurality of users and performs touch determination based on a priority level of the user.

The image receiving module 11 receives an image in which the plurality of users are imaged. The landmark extraction module 13 extracts landmarks of the respective plurality of users. The detection enabled region setting module 14 sets detection enabled regions AR2 of each of the plurality of users based on the lengths of the arms of the plurality of users. The touch determination surface setting module 15 sets touch determination surfaces AR1 of each of the plurality of users based on the lengths of the arms of the plurality of users.

When the plurality of users are imaged, the control device 1 sets a user having a high priority level. The determination module 18 operates the display 60 based on a positional relation between the position of the fingertip 72 of the user having the high priority level and the touch determination surface AR1.

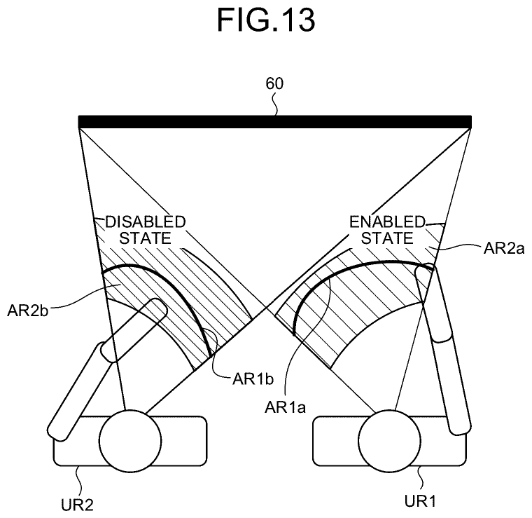

Here, FIG. 13 illustrates an example of a positional relation between the plurality of users and the display 60. As illustrated in FIG. 13, when the user UR1 and the user UR2 are present near the display 60, the control device 1 sets a touch determination surface AR1a and a detection enabled region AR2a of the user UR1. The control device 1 sets a touch determination surface AR1b and a detection enabled region AR2b of the user UR2.

Then, the control device 1 increases priority levels of the touch determination surface AR1a and the detection enabled region AR2a of the user UR1 with predetermined operation. Consequently, the control device 1 sets the touch determination surface AR1a and the detection enabled region AR2a to an enabled state. Accordingly, the control device 1 sets the touch determination surface AR1b and the detection enabled region AR2b to a disabled state.

Then, the control device 1 changes a display state of the display 60 based on a positional relation between the position of the fingertip 72 of the user UR1 and the touch determination surface AR1a and the detection enabled region AR2a.

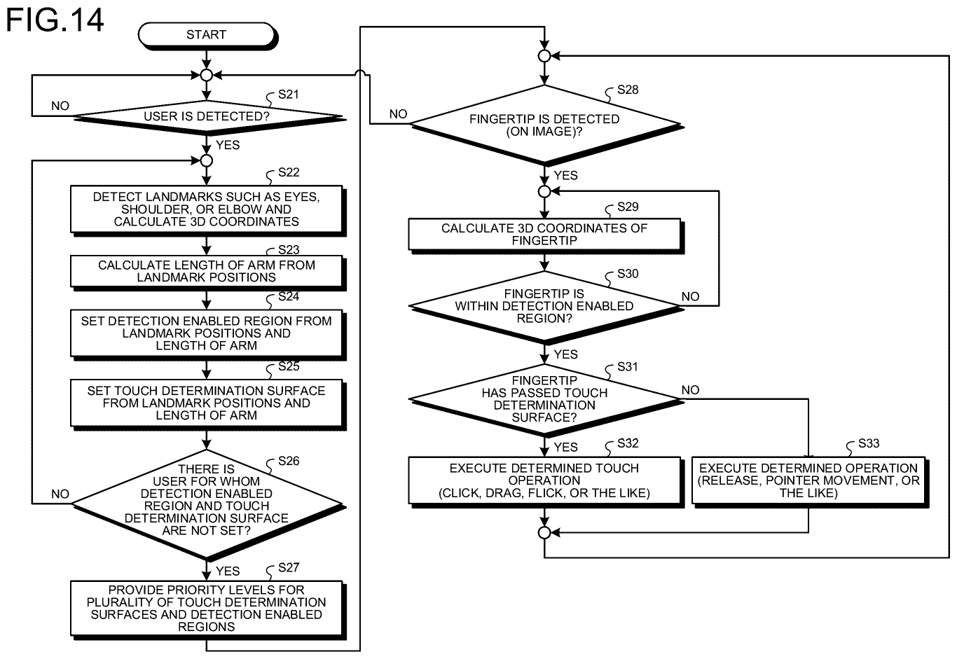

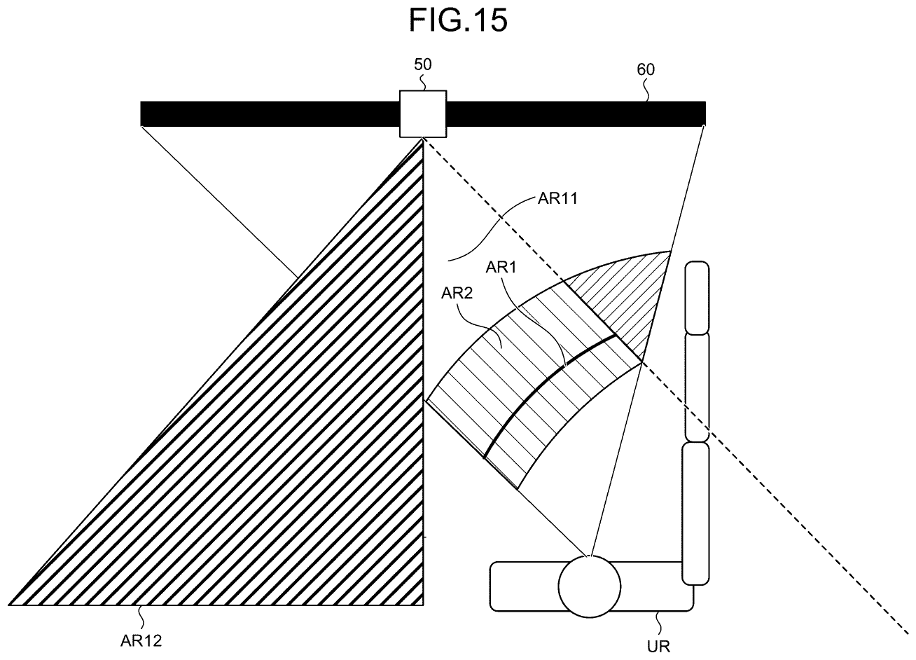

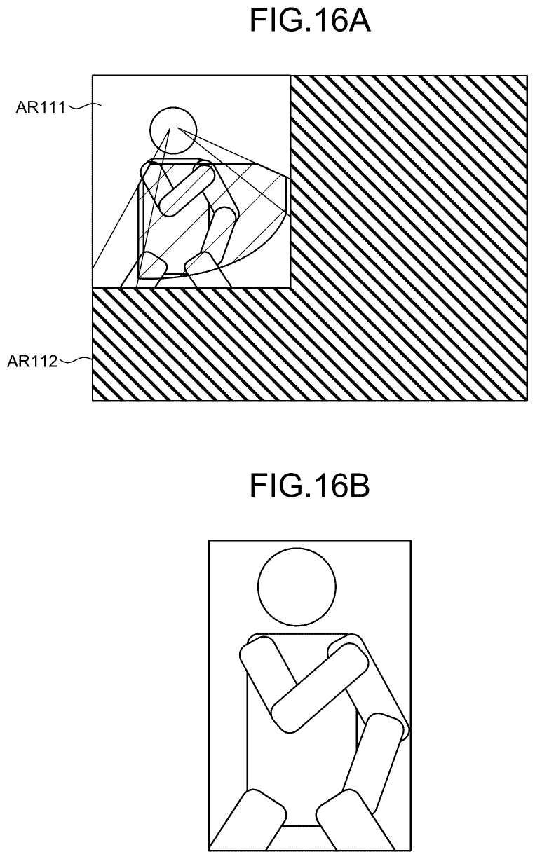

Subsequently, a processing procedure of the control device 1 according to the third embodiment is explained with reference to FIG. 14. FIG. 14 is a flowchart illustrating a processing procedure of the control device 1 according to the third embodiment.

First, the landmark extraction module 13 determines whether a user is detected from an image received by the image receiving module 11 (Step S21). When the landmark extraction module 13 has not detected a user from the image (Step S21: No), the processing proceeds to Step S21 again. When having extracted a user from the image (Step S21: Yes), the landmark extraction module 13 detects landmarks such as eyes, a shoulder, and an elbow and calculates 3D coordinates of the landmarks (Step S22).

The landmark extraction module 13 calculates the length of the arm of the user based on the positions of the landmarks (Step S23).

The detection enabled region setting module 14 sets the detection enabled region AR2 based on the landmark positions and the length of the arm of the user (Step S24). The touch determination surface setting module 15 sets the touch determination surface AR1 based on the landmark positions and the length of the arm of the user (Step S25). When there is a user for whom the detection enabled region AR2 and the touch determination surface AR1 are not set among the users detected from the image (Step S26: Yes), the processing proceeds to Step S22. When touch determination surfaces AR1 and detection enabled regions AR2 of all the users are set, that is, when there is no user for whom the detection enabled region AR2 and the touch determination surface AR1 are not set (Step S26: No), the control device 1 sets priority levels of a plurality of touch determination surfaces AR1 and a plurality of detection enabled regions AR2 (Step S27).

The control device 1 sets the priority levels of the plurality of touch determination surfaces AR1 and the plurality of detection enabled regions AR2 according to, for example, content displayed on the display 60. The control device 1 may set the priority levels after Step S29 explained below. For example, the control device 1 may set high priority levels to the touch determination surface AR1 and the detection enabled region AR2 corresponding to a user located near a fingertip that has started to move first among fingertips whose 3D coordinates have been calculated in Step S29.

The 3D coordinate calculation module 16 determines whether the fingertip 72 of any user has been detected on the image (Step S28). When the 3D coordinate calculation module 16 has not detected a fingertip of the user UR from the image in Step S28 (Step S28: No), the processing proceeds to Step S21. When having detected a fingertip of any user UR from the image (Step S28: Yes), the 3D coordinate calculation module 16 calculates 3D coordinates of the fingertip (Step S29). The determination module 18 determines whether the 3D coordinate of the fingertip is within the detection enabled region AR2 having the highest priority level (Step S30). When the determination module 18 has determined that the fingertip is not within the detection enabled region AR2 (Step S30: No), the processing proceeds to Step S29.

When having determined in Step S30 that the 3D coordinate of the fingertip is within the detection enabled region AR2 having the highest priority level (Step S30: Yes), the determination module 18 determines whether the fingertip has passed the touch determination surface AR1 with the highest priority level (Step S31). When having determined in Step S31 that the fingertip has passed the touch determination surface AR1 having the highest priority level (Step S31: Yes), the determination module 18 determines operation corresponding to the movement of the fingertip. The operation corresponding to the movement of the fingertip is, for example, touch operation. Specific examples of the touch operation include click operation, drag operation, and flick operation. The function execution module 19 executes the determined touch operation (Step S32). When having determined in Step S31 that the fingertip has not passed the touch determination surface AR1 (Step S31: No), the determination module 18 determines operation corresponding to the movement of the fingertip. The operation corresponding to the movement of the fingertip is, for example, release operation or pointer movement operation. The function execution module 19 executes the determined operation (Step S33).

As explained above, when the plurality of detection enabled regions AR2 and the plurality of touch determination surfaces AR1 are set, the control device 1 according to the third embodiment can operate the display 60 based on the detection enabled region AR2 and the touch determination surface AR1 having higher priority levels. Consequently, it is possible to operate the display 60 based on an operation of the user more appropriate as an operation for performing operation instruction.

### Fourth Embodiment

Subsequently, the control device 1 according to a fourth embodiment is explained. The control device 1 according to the fourth embodiment removes, from an image, an unnecessary region where a user is not imaged and operates the display 60 based on a positional relation between the position of a finger detected from the image, from which the unnecessary region has been removed, and the detection enabled region AR2 and the touch determination surface AR1.

FIG. 15 illustrates an example of a positional relation between the user and the display 60. In the example illustrated in FIG. 15, the range that can be imaged by the sensor 50 includes a region AR11 and a region AR12. The region AR11 includes the detection enabled region AR2 and the touch determination surface AR1. On the other hand, the region AR12 does not include the detection enabled region AR2 and the touch determination surface AR1. Accordingly, even if the finger is located in the region AR12, the control device 1 does not need to perform coordinate calculation for the finger. Therefore, the image processing module 12 of the control device 1 performs removal processing of removing a portion corresponding to the region AR12 in the image. The image processing module 12 performs the removal processing, for example, by trimming a portion corresponding to the region AR12. By performing the removal processing, it is possible to reduce a coordinate calculation region, which is a region where the coordinate calculation is performed in the image.

The image processing module 12 may perform the removal processing by removing a portion other than a portion where the user is imaged in the image. Here, an example of the removal processing is explained with reference to FIGS. 16A and 16B.

The image processing module 12 performs removal processing of leaving only a region AR111 of the portion where the user is imaged and removing, from the image illustrated in FIG. 16A, a region AR112 that is not the portion where the user is imaged. As a result of the removal processing, as illustrated in FIG. 16B, an image in which only the region AR111 of the portion where the user is imaged remains is obtained. As a result, the coordinate calculation region is only the region AR111.

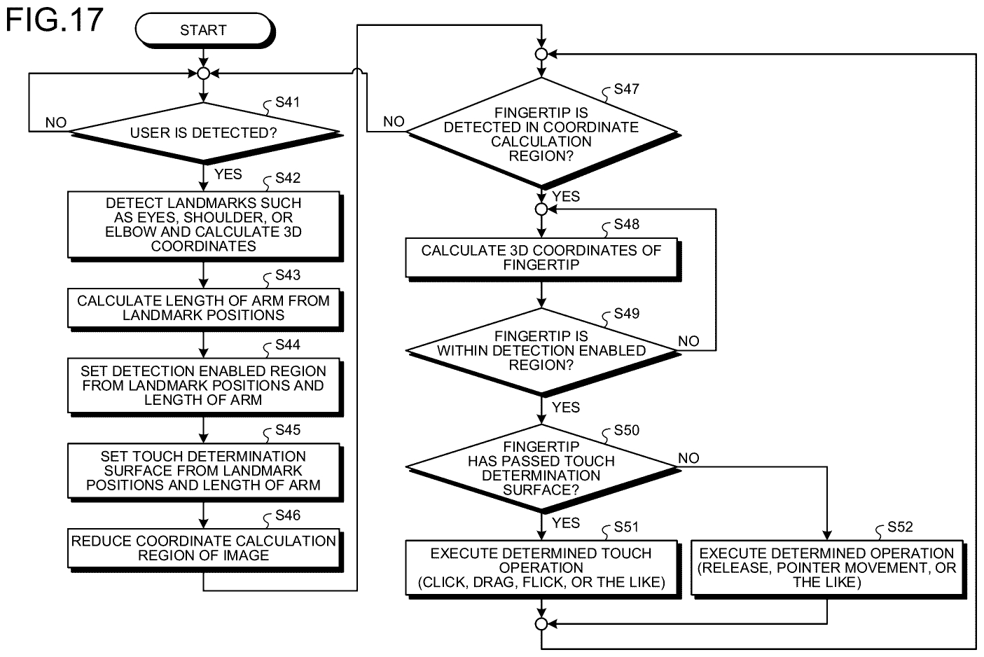

Subsequently, a processing procedure of the control device 1 according to the fourth embodiment is explained with reference to FIG. 17. FIG. 17 is a flowchart illustrating a processing procedure of the control device 1 according to the fourth embodiment.

First, the landmark extraction module 13 determines whether the user is detected from the image received by the image receiving module 11 (Step S41). When the landmark extraction module 13 determines that the user is not detected from the image (Step S41: No), the processing proceeds to Step S1 again. When it is determined that the user is detected from the image (Step S41: Yes), the landmark extraction module 13 detects landmarks such as eyes, a shoulder, and an elbow and calculates 3D coordinates of the landmarks (Step S42).

The landmark extraction module 13 calculates the length of the arm of the user based on the positions of the landmarks (Step S43).

The detection enabled region setting module 14 sets a detection enabled region based on the landmark positions and the length of the arm of the user (Step S44). The touch determination surface setting module 15 sets a touch determination surface based on the landmark positions and the length of the arm of the user (Step S45).

The image processing module 12 reduces the coordinate calculation region of the image with the removal processing (Step S46). The 3D coordinate calculation module 16 determines whether the fingertip 72 of the user UR is detected in the coordinate calculation region on the image (Step S47). In Step S47, when the 3D coordinate calculation module 16 determines the fingertip of the user UR is not detected in the coordinate calculation region on the image (Step S47: No), the processing proceeds to Step S41. When it is determined that the fingertip of the user UR is detected in the coordinate calculation region on the image (Step S47: Yes), the 3D coordinate calculation module 16 calculates 3D coordinates of the fingertip (Step S48). The determination module 18 determines whether the 3D coordinate of the fingertip is within the detection enabled region AR2 (Step S49). When the determination module 18 determines that the fingertip is not within the detection enabled region AR2 (Step S49: No), the processing proceeds to Step S48.

When having determined in Step S49 that the 3D coordinate of the fingertip is within the detection enabled region AR2 (Step S49: Yes), the determination module 18 determines whether the fingertip has passed the touch determination surface (Step S50). When having determined in Step S50 that the fingertip has passed the touch determination surface AR1 (Step S50: Yes), the determination module 18 determines operation corresponding to the movement of the fingertip. The operation corresponding to the movement of the fingertip is, for example, touch operation. Specific examples of the touch operation include click operation, drag operation, and flick operation. The function execution module 19 executes the determined operation (Step S51). When having determined in Step S50 that the fingertip has not passed the touch determination surface AR1 (Step S50: No), the determination module 18 determines operation corresponding to the movement of the fingertip. The operation corresponding to the movement of the fingertip is, for example, release operation or pointer movement operation. The function execution module 19 executes the determined operation (Step S52).

As explained above, the control device 1 according to the fourth embodiment removes, from a coordinate calculation target, a position largely deviating from the positions of the detection enabled region AR2 and the touch determination surface AR1 in the image. This makes it possible to reduce a processing load in the control device 1.

### Modifications

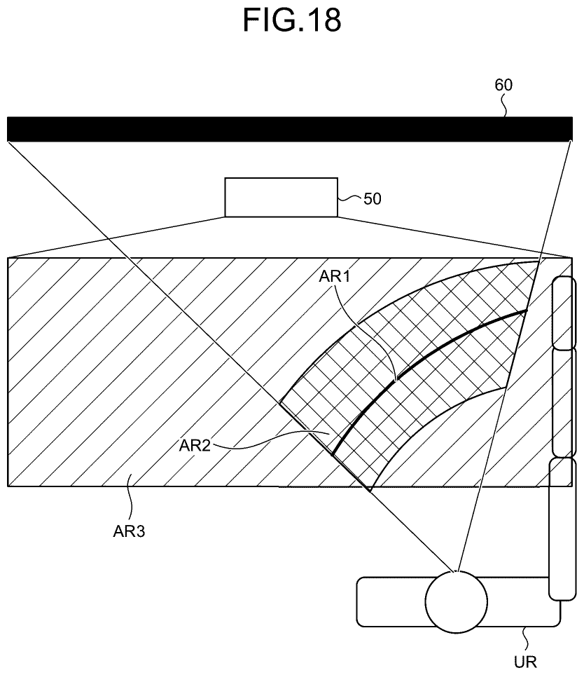

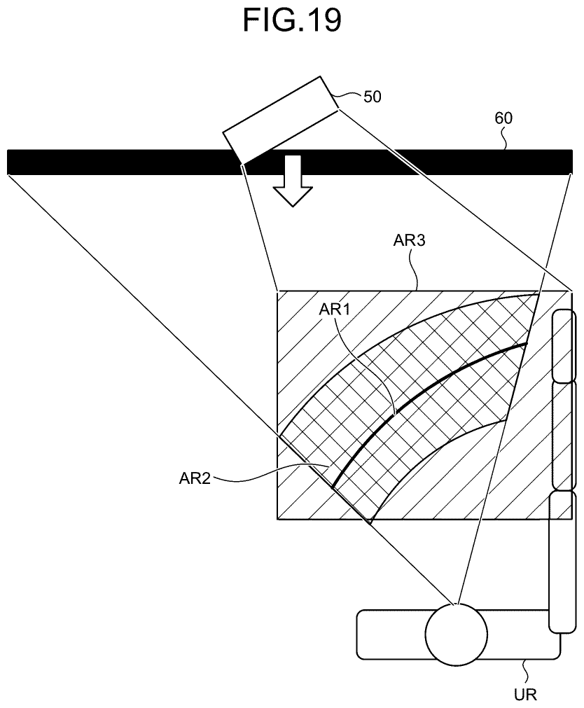

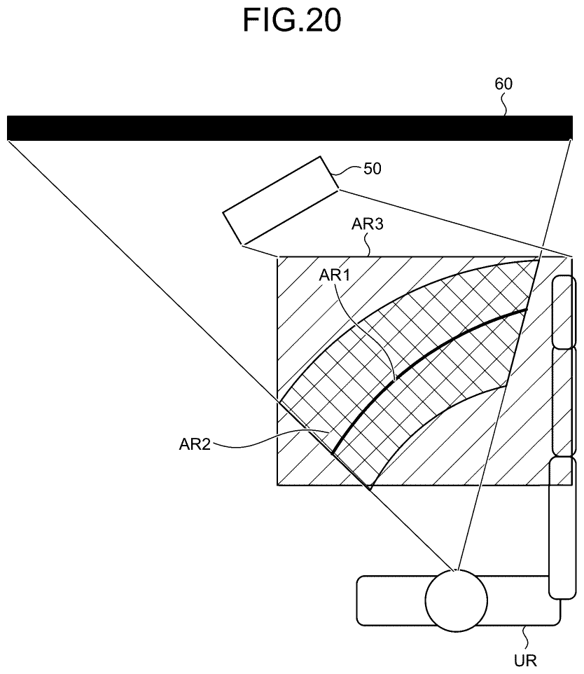

Although not particularly explained in the embodiments explained above, the position of the sensor 50 may be arranged as appropriate based on the positional relation between the user UR and the display 60. For example, as illustrated in FIG. 18, the sensor 50 may be arranged at a position in front of the display 60. In this case, the detection enabled region AR2 and the touch determination surface AR1 can be more securely included in a sensing area AR3 that is a range imaged by the sensor 50.

As illustrated in FIG. 19, the sensor 50 may be arranged to be directed in the direction of the user UR. For example, when the user UR is located on the right side with respect to the display 60, the sensor 50 may be arranged in the right direction. In this case, since the control device 1 can narrow down the sensing area AR3 to the periphery of the user UR, it is possible to reduce the possibility of the control device 1 erroneously detecting movements of other users.

As illustrated in FIG. 20, the sensor 50 may be arranged at a position in front of the display 60 and the sensor 50 may be arranged to be directed in the direction of the user UR.

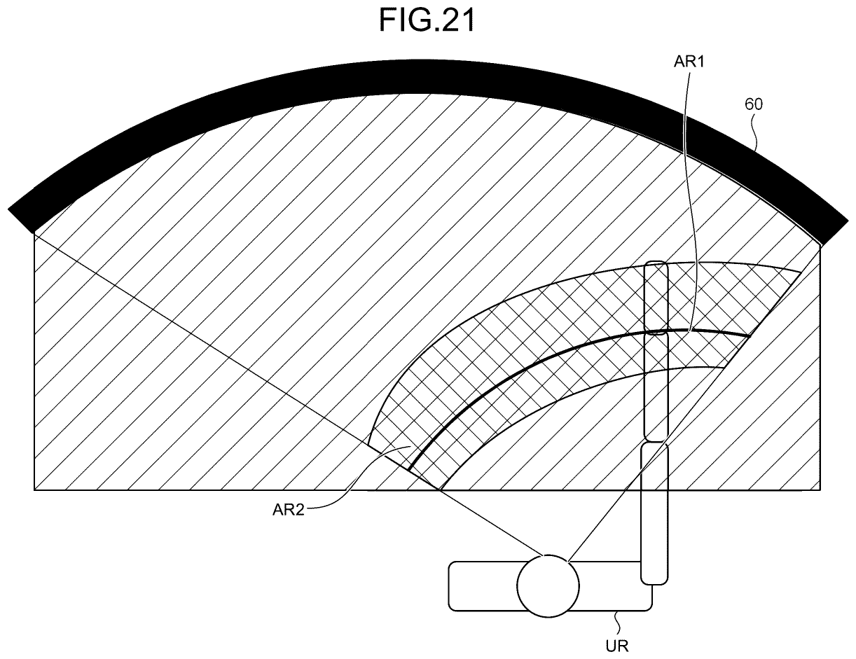

The shape of the display 60 is optional. For example, as illustrated in FIG. 21, the display 60 having a curved surface shape may be used.

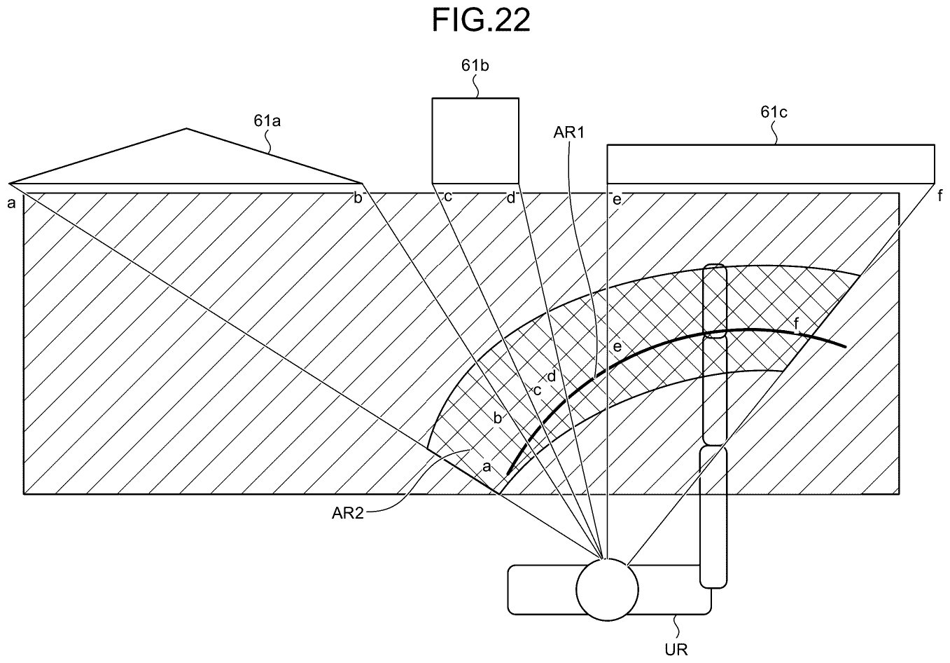

The control device 1 may set detection enabled regions AR2 and touch determination surfaces AR1 corresponding to a plurality of devices. For example, as illustrated in FIG. 22, the control device 1 may set detection enabled regions AR2 and touch determination surfaces AR1 corresponding to all of devices 61a, 61b, and 61c. In this case, the control device 1 may decide a visual field range for each device and perform operation control based on a positional relation between the position of the finger of the user UR and the detection enabled regions AR2 and the touch determination surfaces AR1 and visual field ranges of the respective devices.

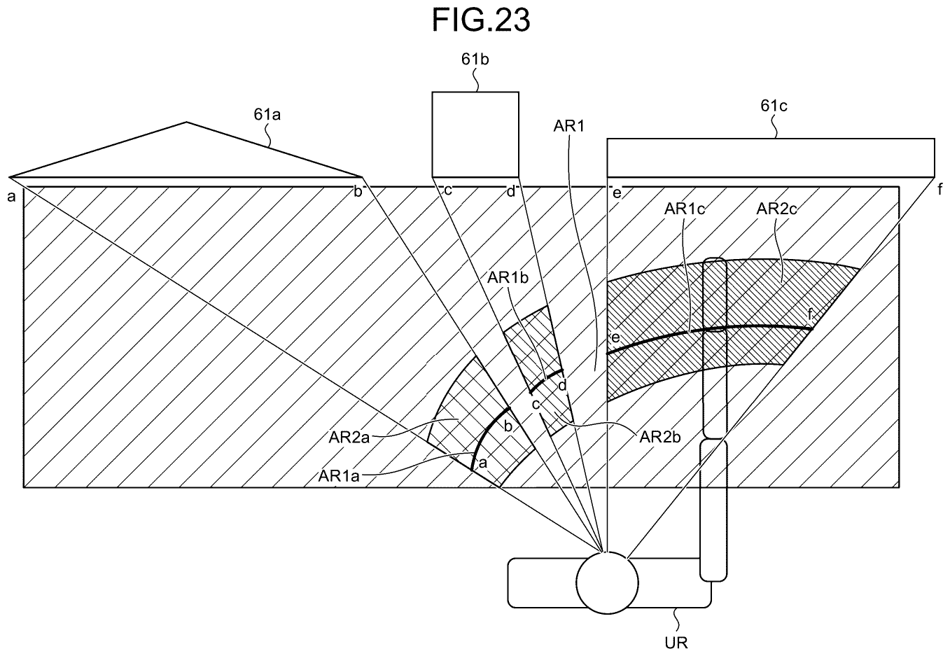

The control device 1 may respectively set the detection enabled regions AR2 and the touch determination surfaces AR1 corresponding to the respective devices 61 considering the visual field ranges of the respective devices 61. For example, as illustrated in FIG. 23, the control device 1 sets the detection enabled region AR2a to a detection enabled region AR2c and the touch determination surface AR1a to a touch determination surface AR1c considering the visual field ranges of the respective devices 61. As explained above, the control device 1 sets the touch determination surfaces such that the touch determination surface AR1a to the touch determination surface AR1c do not overlap one another.

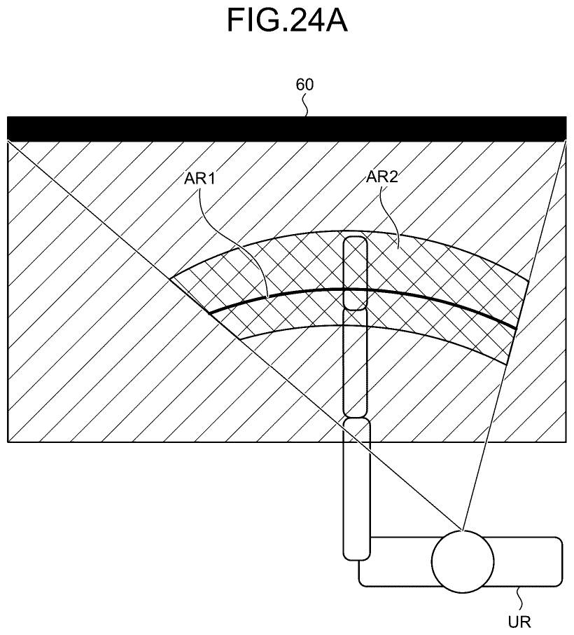

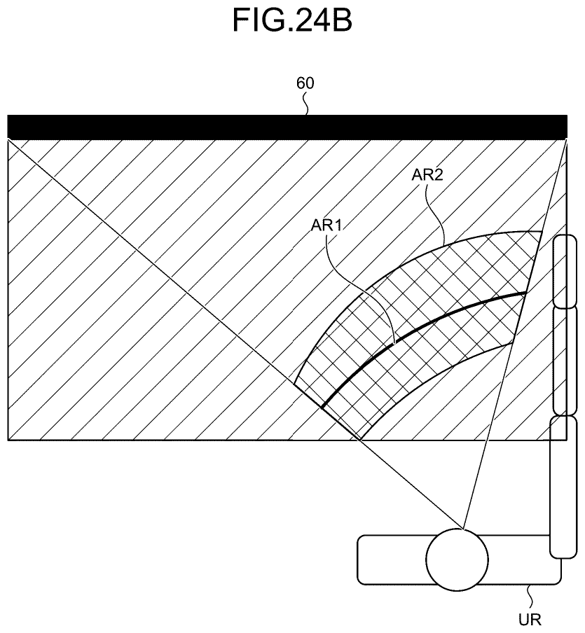

Although the case in which the control device 1 sets the detection enabled region AR2 and the touch determination surface AR1 based on the position and the length of the right arm 71 is explained above, the detection enabled region AR2 and the touch determination surface AR1 may be set based on the position and the length of the left arm 71. As illustrated in FIGS. 24A and 24B, the detection enabled region AR2 and the touch determination surface AR1 (FIG. 24A) for the left arm 71 based on the position and length of the left arm 71 and the detection enabled region AR2 and the touch determination surface AR1 (FIG. 24B) for the right arm 71 based on the position and length of the right arm 71 may be respectively set.

In this case, the determination module 18 determines whether a finger detected from an image is of a finger of the right arm or a finger of the left arm and then determines a positional relation between the position of the detected finger and the detection enabled region AR2 and touch determination surface AR1 corresponding to the finger.

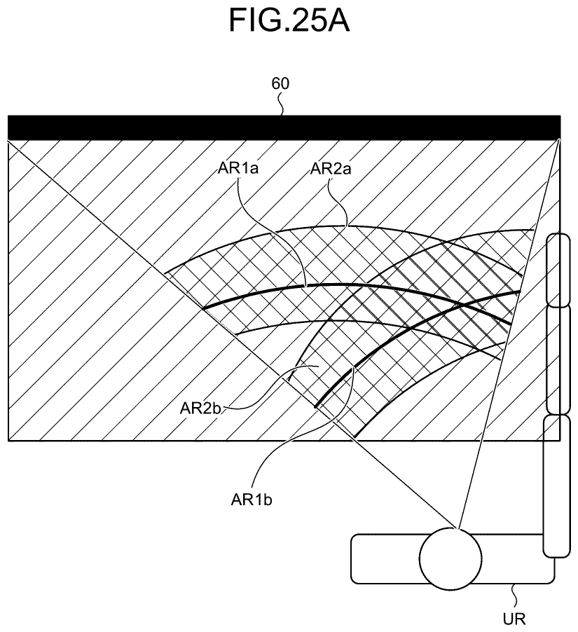

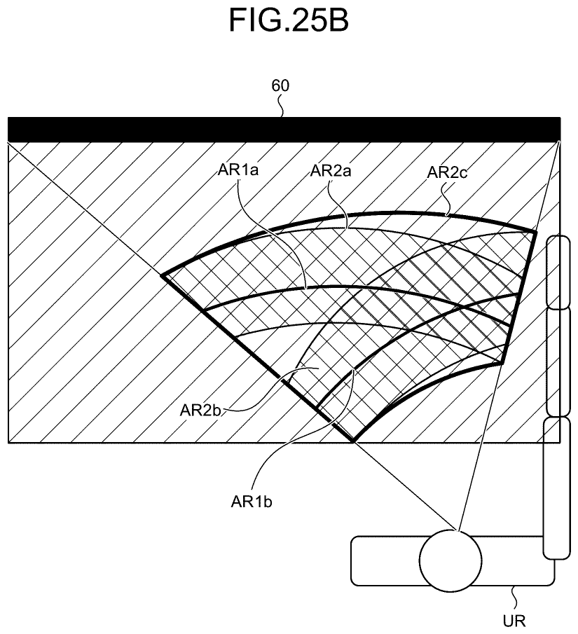

Note that a region obtained by adding together the detection enabled region AR2a corresponding to the left arm 71 and the detection enabled region AR2b corresponding to the right arm 71 illustrated in FIG. 25A may be set as a detection enabled region. As illustrated in FIG. 25B, the detection enabled region AR2c including the detection enabled region AR2a and the detection enabled region AR2b illustrated in FIG. 25A may be set.

In this case, the determination module 18 determines a positional relation between the position of the finger and the detection enabled region AR2c regardless of whether the finger detected from the image is the finger of the right arm or the finger of the left arm. For determination of a positional relation between the position of the finger and the touch determination surface AR1, the determination module 18 distinguishes whether the finger is the finger of the left arm or the finger of the right arm and determines positional relations between the touch determination surface AR1 and the fingers corresponding to each other.

Concerning the embodiments explained above, the following is disclosed.

An information processing device includes:
a memory in which a program is stored; and
a processor coupled to the memory and configured to perform processing by executing the program, the processing including:
   receiving an image obtained by imaging a user;
   detecting an arm portion of the user based on the image;
   setting a detection region, which is a region where a position change of a fingertip of the user is detected, based on a position of the arm portion of the user and a length of the arm portion of the user; and
   operating an individual device based on a positional relation between a position of the fingertip of the user received from the image and the detection region.

Although the embodiments of the present disclosure are explained above, the embodiments explained above are presented as examples and are not intended to limit the scope of the invention. These new embodiments can be implemented in other various forms, and various omissions, substitutions, and changes can be made without departing from the gist of the invention. These novel embodiments and modifications thereof are included in the scope and gist of the invention, and are included in the invention described in the claims and the scope of equivalents of the claims. Further, components in different embodiments and modifications may be combined as appropriate.

The notation of the “ . . . module” in the embodiments explained above may be replaced with another notation such as “ . . . circuitry”, “ . . . assembly”, “ . . . device”, and “ . . . unit”.

In the embodiments, the present disclosure is explained as being configured using hardware as an example. However, the present disclosure can also be implemented by software in cooperation with the hardware.

The functional blocks used in the explanation of the embodiments explained above are typically implemented as an LSI which is an integrated circuit. The integrated circuit may control the functional blocks used for the explanation of the embodiments explained above and include an input terminal and an output terminal. These may be individually integrated into one chip or may be integrated into one chip to include a part or all of them. Although the LSI is referred to herein, the LSI is sometimes referred to as IC, system LSI, super LSI, or ultra LSI depending on a difference in an integration degree.

A circuit integration method is not limited to the LSI and may be implemented using a dedicated circuit or a general-purpose processor and a memory. An FPGA (Field Programmable Gate Array) that can be programmed after LSI fabrication or a reconfigurable processor that can reconfigure connection or setting of circuit cells inside the LSI may be used.

Further, when a circuit integration technology replacing the LSI appears through the progress of the semiconductor technology or another derived technology, naturally, the functional blocks may be integrated using the technology. For example, application of biotechnology is possible.

Furthermore, the effects of the embodiments described in the present specification are merely examples and are not limited, and other effects may be provided.

According to the information processing device of the present disclosure, it is possible to set a virtual operation region that is easy for a user to operate.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing device comprising:
a memory in which a program is stored; and
a processor coupled to the memory and configured to perform processing by executing the program, the processing including:
receiving an image obtained by imaging a user;
detecting an arm portion of the user based on the image;
setting, based on a position of the arm portion of the user and a length of the arm portion of the user, a virtual operation region for accepting an operation on an individual device; and
operating the individual device based on a positional relation between a position of a fingertip of the user received from the image and the virtual operation region.

2. The information processing device according to claim 1, wherein the processing includes setting the virtual operation region based on an entire length of the arm portion of the user.

3. The information processing device according to claim 1, wherein the processing includes setting the virtual operation region based on a length from an elbow to a hand within the arm portion of the user.

4. The information processing device according to claim 1, wherein the processing includes setting the virtual operation region based on a movable range of the arm portion of the user.

5. The information processing device according to claim 1, wherein
the processing includes:
detecting a visual field range of the user based on the image; and
setting the virtual operation region further based on the visual field range of the user.

6. The information processing device according to claim 5, wherein the processing includes setting only a portion included in the visual field range of the user as the virtual operation region.

7. The information processing device according to claim 1, wherein
the processing includes:
setting, based on the position of the arm portion of the user and the length of the arm portion of the user, a detection region that is a region for detecting a position change of the fingertip of the user; and
operating the individual device based on a positional relation between the position of the fingertip of the user received from the image and the detection region.

8. The information processing device according to claim 7, wherein the processing includes setting the detection region based on a first range that is a spherical range based on the length of the arm portion of the user and a second range that is a spherical range based on a length equal to or smaller than the length of the arm portion of the user.

9. The information processing device according to claim 7, wherein
the processing includes:
detecting a visual field range of the user based on the image; and
setting the detection region further based on the visual field range of the user.

10. The information processing device according to claim 9, wherein the processing includes setting only a portion included in the visual field range of the user as the detection region.

11. The information processing device according to claim 7, wherein the processing includes setting the detection region based on a movable range of the fingertip of the user.

12. The information processing device according to claim 1, wherein
the processing includes:
detecting arm portions of a plurality of users; and
setting virtual operation regions of each of the plurality of users based on lengths of the arm portions of the plurality of users; and
operating the individual device based on a positional relation between a position of a fingertip of one user of the plurality of users received from the image and a virtual operation region having a high priority level among the virtual operation regions.

13. The information processing device according to claim 1, wherein the processing includes detecting the fingertip of the user from an image from which a region where the user is not imaged is removed from the image, and operating the individual device based on a positional relation between the fingertip and the virtual operation region.

14. The information processing device according to claim 1, wherein
the individual device includes a plurality of devices arranged side by side, and
the processing includes setting virtual operation regions of each of the plurality of devices so that the virtual operation regions do not overlap.

15. The information processing device according to claim 1, wherein
the processing includes:
detecting left and right arm portions of the user; and
setting left and right virtual operation regions based on respective lengths of the left and right arm portions of the user.

16. The information processing device according to claim 1, wherein the processing includes setting the virtual operation region based on a spherical range based on the length of the arm portion of the user and a position of a shoulder portion of the user.

17. An information processing system comprising a camera, an information processing device, and a display,
the camera capturing an image including a user, and
the information processing device comprising:
a memory in which a program is stored; and
a processor coupled to the memory and configured to perform processing by executing the program, the processing including:
receiving the image;
detecting an arm portion of the user based on the image;
setting, based on a position of the arm portion of the user and a length of the arm portion of the user, a virtual operation region for accepting an operation on the display; and
operating the display based on a positional relation between a position of a fingertip of the user received from the image and the virtual operation region.

18. The information processing system according to claim 17, wherein the camera is arranged based on a positional relation between a position of the user and the display.

19. An information processing method executed by an information processing device, the method comprising:
receiving an image obtained by imaging a user;
detecting an arm portion of the user based on the image;
setting, based on a position of the arm portion of the user and a length of the arm portion of the user, a virtual operation region for accepting an operation on an individual device; and
operating the individual device based on a positional relation between a position of a fingertip of the user received from the image and the virtual operation region.
